(19) United States
(12) Patent Application Publication
(10) Pub. No.: US 2025/0112317 A1
(43) Pub. Date: Apr. 3, 2025

(54) BATTERY SYSTEM

(71) Applicant: SAMSUNG SDI CO., LTD., Yongin-si (KR)

(72) Inventors: Wolfgang REINPRECHT, Attendorf (AT); Stefan REINPRECHT, Attendorf (AT)

(21) Appl. No.: 18/639,817

(22) Filed: Apr. 18, 2024

(30) Foreign Application Priority Data
Sep. 28, 2023 (EP) 23200593.4

(51) Int. Cl. H01M 50/271; H01M 10/658; H01M 50/204; H01M 50/289; H01M 50/367

(52) U.S. Cl. CPC H01M 50/271; H01M 10/658; H01M 50/204; H01M 50/289; H01M 50/367; H01M 2220/20

(57) ABSTRACT

A battery system includes a housing, battery cells in the housing, and including venting exits for allowing a venting gas stream to exit at top or bottom sides of the battery cells, a bottom plate covering the bottom sides of the battery cells, a crossbeam separating neighboring ones of the battery cells, including a lower end on the bottom plate, and extending from the bottom plate to be adjacent the top sides of the neighboring ones of the battery cells, a cover plate extending from one of the neighboring ones of the battery cells over the crossbeam to another one of the neighboring ones of the battery cells to cover an upper end of the crossbeam, and to at least partly cover the top sides of the neighboring ones of the battery cells, the cover plate being configured to be fixed to the crossbeam via a first fixation member.

### CROSS-REFERENCE TO RELATED APPLICATION

The present application claims priority to and the benefit of European Patent Application Ser. No. 23/200,593.4, filed on Sep. 28, 2023, in the European Intellectual Property Office, the entire disclosure of which is incorporated herein by reference.

### BACKGROUND

### 1. Field

The present disclosure relates to a battery system.

### 2. Description of the Related Art

Recently, vehicles for transportation of goods and peoples, and which use electric power as a source for motion, have been developed. Such an electric vehicle may be an automobile that is propelled by an electric motor that uses energy stored in rechargeable batteries. An electric vehicle may be solely powered by batteries, or may be a form of hybrid vehicle powered by for example a gasoline generator or a hydrogen fuel power cell.

A hybrid vehicle may include a combination of an electric motor and conventional combustion engine. Generally, an electric-vehicle battery (EVB) or a traction battery may be used to power the propulsion of battery electric vehicles (BEVs). Electric-vehicle batteries differ from starting, lighting, and ignition batteries in that they are designed to provide power for sustained periods of time.

A rechargeable or secondary battery differs from a primary battery in that it is designed to be repeatedly charged and discharged, while the latter is designed to provide only an irreversible conversion of chemical to electrical energy. Low-capacity rechargeable batteries may be used as a power supplies for small electronic devices, such as cellular phones, notebook computers and camcorders, while high-capacity rechargeable batteries may be used as a power supplies for electric and hybrid vehicles and the like.

Generally, rechargeable batteries include an electrode assembly including a positive electrode, a negative electrode, and a separator interposed between the positive and negative electrodes. The rechargeable batteries may also generally include a case for receiving the electrode assembly, and an electrode terminal electrically connected to the electrode assembly. An electrolyte solution may be injected into the case to enable charging and discharging of the battery via an electrochemical reaction of the positive electrode, the negative electrode, and the electrolyte solution. The shape of the case, such as cylindrical or rectangular, may be selected based on the battery's intended purpose. Lithium-ion (and similar lithium polymer) batteries, widely known via their use in laptops and consumer electronics, dominate the most recent group of electric vehicles in development.

Rechargeable batteries may be used as a battery module formed of a plurality of unit battery cells coupled to each other in series and/or in parallel so as to provide a high density, such as for motor driving of a hybrid vehicle. For example, the battery module may be formed by interconnecting the electrode terminals of the plurality of unit battery cells in an arrangement or configuration depending on a desired amount of power, and to realize a high-power rechargeable battery.

Battery modules may be constructed in either a block design or in a modular design. In the block design, each battery may be coupled to a common current collector structure, and a common battery management system and the unit thereof may be arranged in a housing. In the modular design, pluralities of battery cells may be connected together to form submodules, and several submodules may be connected together to form the battery module. In automotive applications, battery systems generally include of a plurality of battery modules connected in series for providing a desired voltage. The battery modules may include submodules with a plurality of stacked battery cells, and each stack may include cells connected in parallel that are, in turn, connected in series (XpYs), or may include cells connected in series that are, in turn, connected in parallel (XsYp).

A battery pack is a set of any number of (usually generally identical) battery modules. The battery modules may be configured in series, in parallel, or a mixture of both to deliver the desired voltage, capacity, and/or power density. Components of a battery pack may include the individual battery modules, and also may include the interconnects that provide electrical conductivity between the battery modules.

Mechanical integration of such a battery pack incorporates suitable mechanical connections between the individual components of battery modules, and also between the battery modules, and also incorporates a supporting structure of the vehicle. These connections and structure are designed to remain functional throughout the average service life of the battery system. Further, installation space and interchangeability standards may exist (e.g., in mobile applications).

Mechanical integration of battery modules may be achieved by providing a carrier framework, and by positioning the battery modules thereon. The battery cells or battery modules may be fixed by using fitted depressions in the framework, or by using mechanical interconnectors, such as bolts or screws. In other examples, the battery modules may be confined by fastening side plates to lateral sides of the carrier framework. Further, cover plates may be fixed atop and below the battery modules.

The carrier framework of the battery pack may be mounted to a carrying structure of the vehicle. If the battery pack is fixed at the bottom of the vehicle, the mechanical connection may be established from the bottom side by, for example, bolts passing through the carrier framework of the battery pack. The framework may be generally made of aluminum or an aluminum alloy to lower the total weight of the construction.

A thermal management system may provide thermal control of the battery pack to safely use the battery module by efficiently emitting, discharging, and/or dissipating heat generated from its rechargeable batteries. If the heat emission/discharge/dissipation is not sufficiently performed, temperature deviations may occur between respective battery cells, such that the battery module may no longer generate a desired amount of power. An increase of the internal temperature can lead to abnormal reactions occurring in the battery cells, and charging and discharging performance of the rechargeable batteries may deteriorate, and the life-span of the rechargeable batteries may be shortened.

Exothermic decomposition of cell components may lead to a so-called thermal runaway. Generally, thermal runaway describes a process that accelerates due to increased temperature, in turn releasing energy that further increases temperature. Thermal runaway may occur if an increase in temperature changes conditions in a way that causes a further increase in temperature, potentially leading to a destructive result. In rechargeable battery systems, thermal runaway may be associated with strong exothermic reactions that are accelerated by temperature rise. These exothermic reactions may include combustion of flammable gas compositions within the battery pack housing.

For example, if a cell is heated above a critical temperature (typically above about 150° C.), then the battery cell can transition into a thermal runaway. The initial heating may be caused by a local failure, such as a battery cell internal short circuit, heating from a defect electrical contact, or short circuit to a neighboring battery cell. During the thermal runaway, a failed battery cell (e.g., a battery cell which has a local failure) may reach a temperature exceeding about 700° C. Further, large quantities of hot gas may be ejected from inside of the failed battery cell through the venting opening of the cell housing and into the battery pack. The main components of the vented gas are H₂, CO₂, CO, electrolyte vapor, and other hydrocarbons. The vented gas may be flammable and potentially toxic. The vented gas may also cause a gas-pressure to increase inside the battery pack.

The battery cells of known battery systems are generally usually insulated with plastic foils providing suitable electrical insulation towards the side walls and the bottom within normal operating temperatures of up to about 150° C. The battery cells may be squeezed or glued into the cell compartment of the battery housing towards the bottom and sidewalls, whereas the top side of the battery cells may be generally usually uncovered. During a heat-up of a damaged battery cell caused by, for example, a thermal runaway inside the battery cell, the plastic insulation may melt with the consequence of loss of mechanical fixation. For example, the glue/adhesive between the battery cell and the compartment may lose its fixation capabilities at about 300° C., which may allow the battery cell to move (e.g., if the battery cell ejected a part of its contents/components during the thermal runaway).

The housing of a battery cell generally usually includes aluminum with a rather low melting point (e.g., about 550° C.) in comparison to the generated temperatures (e.g., up to about 1000° C.) inside the battery cell during a thermal runaway event. Relatively high pressures and temperature gradients occurring in such situations may cause the battery cell to burst open at unwanted locations (e.g., at a location other than the dedicated burst plates of the venting exits). This may lead to contamination of the top side of the battery cells, potentially causing arcing and thermal propagation, and potentially allowing the propagation of the thermal runaway event to the remaining battery cells.

### SUMMARY

It is an aspect of the present disclosure to overcome or reduce at least some of the drawbacks of the prior art, and to provide a battery system that more securely handles a thermal runaway of one or more battery cells without damaging components of the battery system.

The present disclosure is defined by the appended claims, with functional equivalents thereof to be included therein. The description that follows is subjected to this limitation. Any disclosure lying outside the scope of said claims is only intended for illustrative as well as comparative purposes.

According to one aspect of the present disclosure, a battery system, which may be for an electric vehicle, includes a housing, battery cells forming a battery pack accommodated in the housing, and including venting exits for allowing a venting gas stream to exit at top sides or at bottom sides of the battery cells, a bottom plate covering the bottom sides of the battery cells, a crossbeam separating neighboring ones of the battery cells, including a lower end on the bottom plate, and extending from the bottom plate to be adjacent the top sides of the neighboring ones of the battery cells, a cover plate extending from one of the neighboring ones of the battery cells over the crossbeam to another one of the neighboring ones of the battery cells to cover an upper end of the crossbeam, and to at least partly cover the top sides of the neighboring ones of the battery cells, the cover plate being configured to be fixed to the crossbeam via a first fixation member.

The bottom plate may be configured to be fixed to the crossbeam via a second fixation member.

The second fixation member may include one or more of bolts or screws.

The first fixation member may include one or more of bolts or screws.

The cover plate may cover electrode terminals at the top sides of the neighboring ones of the battery cells.

The cover plate may be fixed to the top sides of the neighboring ones of the battery cells.

The cover plate may be adapted to a contour of the top sides of the battery cells and the upper end of the crossbeam.

The cover plate may include a structural layer having mechanical rigidity and a first thermal insulation layer.

The battery system may further include a second thermal insulation layer between the crossbeam and one of the neighboring ones of the battery cells.

The second thermal insulation layer may include a woven fabric including glass fibres, basalt fibres, or mica fibres, and a matrix support material.

The first thermal insulation layer may include a woven fabric including glass fibres, basalt fibres, or mica fibres, and a matrix support material.

The structural layer may include metal.

The cover plate fully may cover the top sides of the battery cells.

The venting exits may be at the top sides of the battery cells, wherein the cover plate includes venting openings aligned with the venting exits of the battery cells, and configured to allow the venting gas stream to pass through the cover plate.

Yet another aspect of the present disclosure refers to an electric vehicle including the battery system according to any one of the preceding aspects.

Further aspects of the present disclosure could be learned from the dependent claims or the following description.

### BRIEF DESCRIPTION OF THE DRAWINGS

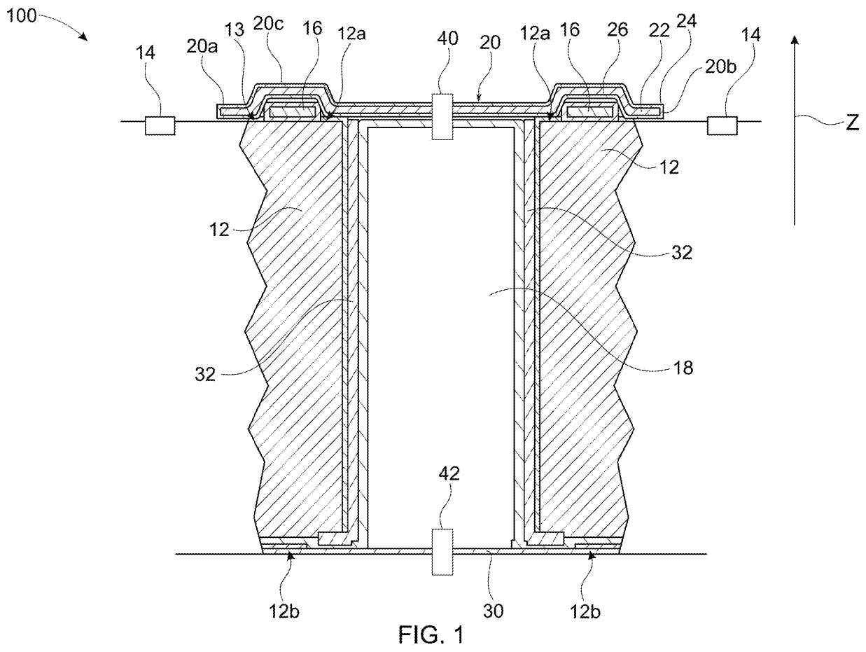

Features will become apparent to those of ordinary skill in the art by describing, in detail, embodiments with reference to the attached drawings in which FIG. 1 illustrates a schematic cross view of a battery system according to one or more embodiments.

### DETAILED DESCRIPTION

Reference will now be made in detail to embodiments, examples of which are illustrated in the accompanying drawings. Aspects of embodiments, and implementation methods thereof will be described with reference to the accompanying drawings. In the drawings, like reference numerals denote like elements, and redundant descriptions are omitted. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described. In the drawings, the relative sizes of elements, layers, and regions may be exaggerated for clarity.

As used herein, the term “and/or” includes any and all combinations of one or more of the associated listed items. Further, the use of “may” when describing embodiments of the present disclosure refers to “one or more embodiments of the present disclosure.” In the following description of embodiments of the present disclosure, the terms of a singular form may include plural forms unless the context clearly indicates otherwise.

It will be understood that although the terms “first” and “second” are used to describe various elements, these elements should not be limited by these terms. These terms are only used to distinguish one element from another element. For example, a first element may be named a second element and, similarly, a second element may be named a first element, without departing from the scope of the present disclosure. As used herein, the term “and/or” includes any and all combinations of one or more of the associated listed items. Expressions, such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof.

It will also be understood that when a film, a region, or an element is referred to as being “above” or “on” another film, region, or element, it can be directly on the other film, region, or element, or intervening films, regions, or elements may also be present.

Herein, the terms “upper” and “lower” as well as “top side” and “bottom side” are defined according to the z-axis. For example, the top side of a battery cell is positioned at the upper part of the z-axis, whereas the bottom side of the battery cell is positioned at the lower part thereof. These terms may refer to the intended installation of the battery system inside an electric vehicle. In the drawings, the sizes of elements may be exaggerated for clarity. For example, in the drawings, the size or thickness of each element may be arbitrarily shown for illustrative purposes, and the embodiments of the present disclosure should not be construed as being limited thereto.

In the following description of embodiments of the present disclosure, the terms of a singular form may include plural forms unless the context clearly indicates otherwise.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Referring to FIG. 1, according to one aspect of the present disclosure, a battery system 100 is provided. The battery system 100 includes a housing, and a plurality of battery cells 12 accommodated inside the housing. The housing may be referred to as a battery housing. The housing may also be considered as a cell compartment for the battery cells 12.

The battery cells 12 may be interconnected via one or more electrical connecting members (e.g., busbars) contacting respective electrodes/cell terminals of the battery cells 12 to form one or more battery modules/battery packs. The battery cells 12 may be arranged to form one or more battery packs. The battery cells 12 in a battery pack may be electrically interconnected (e.g., in series and/or in parallel, as explained above). Multiple battery packs may form a battery module. Two or more of the battery packs may be stacked to form cell stacks.

The battery cells 12 may be, for example, prismatic or cylindrical cells. Each of the battery cells 12 includes a top side 12a at an upper end of the battery cell 12, and a bottom side 12b at a lower end of the battery cell 12. Each of the battery cells 12 includes a venting exit 14 at a venting side 13 of the battery cell 12 (e.g., at the terminal side of the battery cell). The venting exits 14 may allow a venting gas stream to escape the battery cells 12 during a thermal runaway. Venting valves may be provided at the venting exits 14. The venting side 13 may be the top side 12a and/or the bottom side 12b of the battery cells 12 (e.g., one or more venting exits 14 may be provided at the top side 12a and/or the bottom side 12b of the battery cells 12).

The battery system 100 may further include a mechanically rigid bottom plate 30. The battery cells 12 may be arranged on the bottom plate 30. For example, the battery cells 12 may stand on the bottom plate 30. The bottom plate 30 may be arranged at the lower end of the battery cells 12 (e.g., the battery cells 12 may be arranged with their respective bottom sides 12b on the bottom plate). The bottom sides 12b of the battery cells 12 may contact the bottom plate 30. The bottom plate 30 may be mechanically rigid, meaning that the bottom plate 30 is generally devoid of flexibility. The bottom plate 30 may be stiff and generally unyielding at least with respect to forces commonly occurring during a thermal runaway of one or more of the battery cells 12. The bottom plate 30 may be mechanically rigid such that the bottom plate 30 may withstand forces commonly occurring during a thermal runaway of one or more of the battery cells 12 without substantially bending or breaking, and/or such that the bottom plate 30 may stay structurally integrated with the other components of the battery system 100 (e.g., the crossbeam 18 and/or the housing to which the bottom plate 30 is fixed). The rigidity may be achieved by a suitable choice of material (e.g., steel) and/or material thickness.

For example, the bottom plate 30 may extend along the entirety of the bottom side 12b of the battery cells 12. If the venting side 13 of the battery cells 12 is the bottom side 12b, the bottom plate 30 may include venting openings aligned with the venting exits 14 of the battery cells 12 to allow the venting gas stream to pass through the bottom plate 30. The bottom plate 30 may be adapted to withstand the temperatures usually occurring during a thermal runaway (e.g., temperatures of at least about 700° C., or up to about 1000° C.). A cooling element may be arranged at the bottom plate 30, or the bottom plate 30 may itself serve as a cooling element, to enable cooling the battery cells 12 during normal operation.

The battery system 100 may further include one or more crossbeams 18 (e.g., alternately named crossbars) separating neighboring battery cells 12 of the plurality of battery cells 12. In one or more embodiments, the crossbeam 18 may separate neighboring cells of different battery packs. The crossbeam 18 may be arranged with a lower end thereof on the bottom plate 30. The crossbeam 18 may extend from the bottom plate 30 to the top sides 12a of the neighboring battery cells 12. The crossbeam 18 may extend up until the position of the top sides 12a of the battery cells 12. In one or more embodiments, a top side of the crossbeam 18 and the top sides 12a of the neighboring battery cells 12 may have substantially the same height and/or the same position on a z-axis.

As the crossbeam 18 is arranged on the bottom plate 30, the bottom plate 30 may be considered to extend from one of the neighboring battery cells 12 under the crossbeam 18 to the other one of the neighboring battery cells 12 so as to cover the lower end of the crossbeam 18. Also, the bottom plate 30 may at least partly cover the bottom sides 12b of the neighboring battery cells 12. The bottom plate 30 may be considered a lower cover for covering the crossbeam 18 and the neighboring battery cells 12, for example, all of the battery cells 12, or at least all of the battery cells 12 of one of the battery packs.

The crossbeam 18 may be considered to be part of the housing (e.g., part of the cell compartment of the battery system). The crossbeam 18 constitutes a structural component of the battery system 100 giving structural integrity to the battery system 100. The crossbeam 18 may be connected (e.g., structurally connected) to the housing. The crossbeam 18 may be made of aluminum.

The battery system 100 may further include a cover plate 20 covering at least part of the top side 12a of the battery cells 12, and covering (e.g., fully covering) the upper end/top side of the crossbeam 18. The cover plate 20 may extend from a first one of the neighboring battery cells 12 to a second one of the neighboring battery cells 12, thereby spanning the crossbeam 18. The cover plate 20 may be considered an upper cover. The battery system 100 may include multiple cover plates 20 (e.g., may include a cover plate 20 for each arrangement of neighboring battery cells 12 with a crossbeam 18 therebetween).

In one or more embodiments, the cover plate 20 may cover multiple battery cells 12 and one or more crossbeams 18. In one or more embodiments, the cover plate 20 may cover all of the battery cells 12 of the battery system 100 and any crossbeams 18 therebetween. If the venting side 13 of the battery cells 12 is at the top side 12a, the cover plate 20 may include venting openings aligned with the venting exits 14 of the battery cells 12 to allow the venting gas stream pass through the cover plate 20.

The cover plate 20 may be mechanically rigid in the same sense as the bottom plate 30 as explained above. The cover plate 20 being mechanically rigid may mean that the cover plate 20 is devoid of flexibility. The cover plate 20 may be stiff and unyielding at least with respect to forces commonly occurring during a thermal runaway of one or more of the battery cells 12. The cover plate 20 is mechanically rigid such that the cover plate 20 may withstand forces commonly occurring during a thermal runaway of one or more of the battery cells 12 without substantially bending or breaking, and/or such that the cover plate 20 may stay structurally integrated with the further components of the battery system 100 (e.g., the crossbeam 18 to which the cover plate 20 is fixed, and optionally the housing to which the cover plate 20 is fixed). The rigidity may be achieved by a suitable choice of material (e.g., steel) and/or material thickness.

The cover plate 20 is adapted to withstand the temperatures usually occurring during a thermal runaway (e.g., temperatures of at least about 700° C., or at least about 1000° C.). According to the present disclosure, the cover plate 20 may be fixed to the crossbeam 18 via a first fixation member 40. In one or more embodiments, a first fixation member 40 may be provided to fixedly attach the cover plate 20 to the at least one crossbeam 18. The fixation member may be introduced through the cover plate 20 from the outer surface of the cover plate 20 and into the crossbeam 18. The fixation member may fix the cover plate 20 to the crossbeam 18 in a force-fitting, and/or form-fitting, manner. The cover plate 20 may be fixed via such fixation member to multiple or all of the crossbeams 18, if the battery system 100 includes multiple crossbeams 18.

According to the present disclosure, both the bottom plate 30 and the cover plate 20 are mechanically rigid, and both span the crossbeam 18, wherein at least the cover plate 20 is mechanically fixed to the crossbeam 18. This structure achieves a secure fixation of the battery cells 12 inside the battery compartment/housing, for example, in a vertical direction. In one or more embodiments, a vertical or z-axis-fixation is collectively provided by the bottom plate 30, the crossbeam 18, and the cover plate 20 as they are fixed together. The battery system 100 according to the present disclosure has improved structural integrity.

The structure of one or more embodiments including the bottom plate 30, cover plate 20, and the crossbeam 18 is able to withstand pressures and temperatures occurring during a thermal runaway of one or more of the battery cells 12. This ensures that the battery cell 12 experiencing the thermal runaway does not burst open at unwanted locations, and ensures that the venting gas stream leaves the cells only at the venting exits 14 (e.g., only the dedicated burst plates of the venting exists will burst). Further, the melting of any plastic insulation in the battery system 100 during a thermal runaway does not impair the mechanical fixation or structural integrity. In summary, a battery system 100 is provided which, due to an improved structural integrity, more securely handles a thermal runaway of one or more battery cells 12.

According to one or more embodiments, the bottom plate 30 is fixed to the crossbeam 18 via a second fixation member 42. In one or more embodiments, a second fixation member 42 is provided that fixedly attaches the bottom plate 30 to the at least one crossbeam 18, or fixedly attaches the crossbeam 18 to the bottom plate 30. The bottom plate 30 may be fixed via such fixation member to multiple or all of the crossbeams 18, if the battery system 100 includes multiple crossbeams 18. The bottom plate 30 may be fixed to the crossbeam 18 in the same or a similar manner as the cover plate 20 is fixed to the crossbeam 18. This further improves the structural integrity of the system. This structure achieves a secure fixation of the battery cells 12 inside the battery compartment/housing, in a vertical direction, as the vertical or z-axis-fixation is provided by the bottom plate 30, the crossbeam 18, and the cover plate 20 as they are all fixed together.

According to one or more embodiments, the first fixation member 40 may include one or more of bolts and/or screws. According to one or more embodiments, the second fixation member 42 may include one or more of bolts and/or screws. Bolts and/or screws may be used as one or more fixation members. For example, one or more screws may be screwed through an upper end or top side of the cover plate 20 into the crossbeam 18 located beneath the cover plate 20. Similar, one or more screws may be screwed through a lower end or bottom side of the bottom plate 30 into the crossbeam 18 located above the bottom plate 30. Such a fixation member may allow for a simple and secure fixation of the cover plate 20 and/or bottom plate 30, and of the neighboring battery cells 12 at the crossbeam 18.

According to one or more embodiments, the neighboring battery cells 12 may include electrode terminals 16 (e.g., cell terminals) at their top sides 12a, wherein the cover plate 20 covers the electrode terminals 16. The cover plate 20 may extend above the top sides 12a of the neighboring battery cells 12, and may span the areas of the top sides 12a that include the electrode terminals 16. The areas of the top sides 12a that include the electrode terminals 16 may be arranged adjacent to the crossbeam 18. The electrode terminals 16 may be the electrical poles of a respective battery cell 12 for electrical connection of the battery cell 12 with one or more of the other battery cells 12.

The neighboring battery cells 12 may be interconnected with one another via an electrical connecting member contacting the electrode terminals 16 of the respective battery cells 12. The electrical connecting member may span the crossbeam 18. The electrical connecting member may also be covered by the cover plate 20. The cover plate 20 may also cover the electrode terminals 16 (and may possibly cover the electrical connecting member) of the neighboring battery cells 12 to further improve structural integrity, and to further improve the ability of the system to withstand a thermal runaway.

Further, the cover plate 20 may protect the terminals from a venting gas stream (e.g., from particles of the venting gas stream, which may deposit onto the cover plate). The cover plate 20 may cover the crossbeam 18, the terminals, and/or any electrical connecting member(s) in a way such that the crossbeam 18, the terminals, and/or any electrical connecting member(s) are shielded from venting products exhausted by at least one of the battery cells 12 in case of a thermal runaway. This may reduce or prevent the likelihood of arcing between the cells.

According to one or more embodiments, the cover plate 20 may be fixed to the top sides 12a of the neighboring battery cells 12. For example, the cover plate 20 is glued to the top sides 12a of the neighboring battery cells 12. The cover plate 20 may be fixed to one of the neighboring battery cells 12, or to both of the neighboring battery cells 12. If the cover plate 20 also covers the electrode terminals 16, then the cover plate 20 may be fixed to the top sides 12a of the battery cells 12 adjacent to the electrode terminals 16, and adjacent to a side of the respective electrode terminal 16 that is farther away from the crossbeam 18.

For example, the cover plate 20 may be fixed with a left side end 20a thereof to the top side 12a of a left battery cell 12, and may extend from the left side end 20a above an electrode terminal 16 of the left battery cell 12, above the crossbeam 18, to a right side end 20b above an electrode terminal 16 of a right battery cell 12, wherein the cover plate 20 may be fixed by the right side end 20b to the top side 12a of the right battery cell 12. Fixing the cover plate 20 to the top sides 12a of the neighboring battery cells 12 further improves the structural integrity of the system, and ensures that he electrode terminals 16 stay covered by the cover plate 20 even during thermal runaway.

According to one or more embodiments, the cover plate 20 is adapted to both of the contour of the top side 12a of the battery cells 12 and the contour of the upper end of the crossbeam 18. The cover plate 20 is also adapted to the contour of the electrode terminals 16 and/or the electrical connecting member, if present. The cover plate 20 may be adapted to the contour of the top side 12a of the battery cells 12, to the contour of the upper end of the crossbeam 18, and to the contour of the electrode terminals 16. Being adapted to the contour of a member may mean that the cover plate 20 includes a shape corresponding to the shape of the elements covered by the cover plate 20. The contour or form of the cover plate 20 may be adapted to the contour of all the elements that cover plate 20 covers. In one or more embodiments, the cover plate 20 may be adapted in a three-dimensional shape to the parts covered thereby, the top side 12a of the battery cells 12, the upper end of the crossbeam 18, and the electrode terminals 16. Such an adaptation of the cover plate 20 to the covered parts leaves little to no access for the venting products to reach the covered parts to allow for a reliable shielding, and to further improve the structural integrity of the system.

According to one or more embodiments, the cover plate 20 includes a mechanically rigid structural layer 22 and a first thermal insulation layer. The structural layer 22 may give the cover plate 20 its mechanical rigidity and may result in the above-described properties. One or more first thermal insulation layers may provide thermal insulation from the venting gas stream. The one or more thermal insulation layers may also provide electrical insulation. The cover plate 20 may include two first thermal insulation layers (e.g., an upper insulation layer 24 and a lower insulation layer 26), wherein the structural layer 22 is located between the upper insulation layer 24 and the lower insulation layer 26. The cover plate 20 having such insulation layer(s) may provide better protection of the battery cells 12 and their terminals from any venting gas stream. The cover plate 20 having such insulation layer(s) may improve the structural integrity of the system due to less severe heating of the covered components and/or the cover plate 20.

According to one or more embodiments, the battery system 100 includes a second thermal insulation layer 32 arranged between the crossbeam 18 and one of the adjacent battery cells 12. For example, multiple such thermal insulation layers 32 are provided. For example, the battery system 100 may include a thermal insulation layer 32 arranged between the crossbeam 18 and one of the adjacent battery cells 12, and may include another thermal insulation layer 32 arranged between the crossbeam 18 and the other one of the adjacent battery cells 12. The one or more thermal insulation layers 32 may also provide electrical insulation. Insulation may be provided between the battery cells 12 and the crossbeam 18 to allow for better protection of a battery cell 12 from a thermal runaway event occurring in a neighboring cell. Also, the insulation may improve the structural integrity of the system due to less severe heating of the crossbeam 18.

According to one or more embodiments, the first thermal insulation layer includes a woven fabric and a matrix support material. According to one or more embodiments, the second thermal insulation layer includes a woven fabric and a matrix support material. The woven fabric may include one or more of glass fibres, basalt fibres, or mica fibres. Mica may mean mica silicate minerals. The matrix support material may include a resin. The matrix support material may provide stability to the insulation layer. One or more of the insulation layers 24, 26, 32 may include a FR-4 coating or material. FR-4 is a composite material composed of woven fiberglass fabric with an epoxy resin binder that is flame resistant (or self-extinguishing) according to the National Electrical Manufacturers Association (NEMA) grade designation for glass-reinforced epoxy laminate material. The woven fabric of the insulation layer may be flexible enough to tightly fit to the outer surface of the adjacent components.

According to one or more embodiments, the structural layer 22 may be a metal layer. The structural layer 22 may be a steel layer. The structural layer 22 may include metal/steel or may be mainly included of metal/steel. Metal (e.g., steel) is suited for providing the structural layer 22 and the cover plate 20 with stiffness, and may make the cover plate 20 mechanically rigid. The material thickness of the structural layer 22 may be chosen depending on the material such that the cover plate 20 is sufficiently mechanically rigid to withstand the above-explained forces during a thermal runaway. According to one or more embodiments, the structural layer 22 may be a bi-metallic plate (e.g., a steel alloy). The cover plate 20 may include, or may be mainly included of, a bi-metallic composition (e.g., a steel alloy).

According to one or more embodiments, the cover plate 20 may fully cover the top sides 12a of the battery cells 12. According to one or more embodiments, the venting sides 13 may be arranged at the top sides 12a of the battery cells 12, the cover plate 20 including venting openings aligned with the venting exits 14 of the battery cells 12 for letting the venting gas stream pass through the cover plate 20. In one or more embodiments, the cover plate 20 may extend along the entirety of the top sides 12a/venting sides 13 of the battery cells 12. The cover plate 20 may fully cover the battery cells 12 at an upper side thereof. For example, the cover plate 20 may fully cover the venting sides 13 of the battery cells 12 aside from the venting openings, so that a venting gas stream leaving one or more of the battery cells 12 through their respective venting exits 14 may still pass through the cover plate 20. The cover plate 20 fully covering the battery cells 12 may further improve the structural integrity of the system. If the top sides 12a include the venting sides 13 of the battery cells 12, the cover plate 20 may completely shield the battery cells 12 at their venting sides 13 from the venting gas stream, and from venting products (e.g., particles) of the venting gas stream, which may deposit only onto the cover plate 20, and not onto the battery cells 12.

The present disclosure also pertains to an electric vehicle including a battery system 100 according to the present disclosure.

FIG. 1 is a cross view illustrating schematically a battery system 100 according to one or more embodiments of the present disclosure. The battery system 100 may include a housing/battery housing for accommodating a plurality of battery cells 12. FIG. 1 shows two neighboring ones of battery cells 12. Each of the neighboring battery cells 12 includes, at a top side 12a thereof, a venting side 13 with a venting exit 14 for allowing a venting gas stream to exit the battery cells 12 during a thermal runaway. The neighboring battery cells 12 are only shown in part. Both the neighboring battery cells 12 include, at their top sides 12a, electrode terminals 16 for electrical connection.

The neighboring battery cells 12 are separated from each other by a crossbeam 18, which extends along the sides of the neighboring battery cells 12, and between the neighboring battery cells 12. The neighboring battery cells 12 may be arranged with their bottom sides 12b on a mechanically rigid bottom plate 30. The crossbeam 18 may also be arranged with its lower end/bottom side on the bottom plate 30. As shown in FIG. 1, the crossbeam 18 may extend from the bottom plate 30 to the top sides 12a of the neighboring battery cells 12 (or adjacent thereto) such that an upper end/top side of the crossbeam 18 is arranged at the same position on a z-axis as the top sides 12a of the adjacent battery cells 12.

The battery system 100 may further include a mechanically rigid cover plate 20 that covers the top sides 12a of the neighboring battery cells 12, including the electrode terminals 16, and that covers the upper end of the crossbeam 18. In one or more embodiments, the cover plate 20 extends, from left to right, from a left side end 20a, above the electrode terminal 16 of the left battery cell 12, then above the crossbeam 18, and then above the electrode terminal 16 of the right battery cell 12, and may end at a right side end 20b. The cover plate 20 is adapted to the contour of the top side 12a of the battery cells 12 and the upper end of the crossbeam 18. In one or more embodiments, the cover plate 20 is adapted to the contour of the electrode terminals 16 via protruding portions 20c of the cover plate 20.

The cover plate 20 is fixed to the crossbeam 18 via a first fixation member 40 (e.g., via one or more screws and/or one or more bolts). The first fixation member 40 may be introduced from the outer surface of the cover plate 20, and may extend through the cover plate 20 into the crossbeam 18. Also, the cover plate 20 may be fixed (e.g., glued) with its left side end 20a to the top side 12a of the left battery cell 12, and with its right side end 20b to the top side 12a of the right battery cell 12. Further, the bottom plate 30 may be fixed to the crossbeam 18 via a second fixation member 42, which may also be one or more screws and/or one or more bolts. The second fixation member 42 may be introduced from the outer surface of the bottom plate 30, and may extend through the bottom plate 30 into the crossbeam 18.

A vertical or z-axis-fixation is provided by the bottom plate 30, the crossbeam 18, and the cover plate 20 as they are fixed together. The rigidity of this structure may be suitably enhanced because both of the cover plate 20 and the bottom plate 30 are mechanically rigid, and are fixed to the crossbeam 18. This structure achieves a secure fixation of the battery cells 12 inside the battery compartment/housing, with respect to a vertical z-direction. The battery system 100 according to the present disclosure provides an improved structural integrity. Furthermore, the structure including the bottom plate, the cover plate, and the crossbeam is able to withstand the pressures and temperatures occurring during a thermal runaway of one or more of the battery cells 12, which may ensure that the battery cell experiencing the thermal runaway does not burst open at unwanted locations, but only at dedicated burst plates of the venting exits 14.

For thermal and electrical insulation, the cover plate 20 may include an upper insulation layer 24 and a lower insulation layer 26 enclosing a mechanically rigid structural layer 22. The structural layer 22 may provide the cover plate 20 with mechanical rigidity. Further, insulation layers 32 may be respectively provided on both sides of the crossbeam 18 to insulate against the adjacent battery cell 12. The insulation layers 24, 26, 32 may include a FR-4 material.

### SOME OF THE REFERENCE CHARACTERS

12: battery cells
12a: top sides of battery cells
12b: bottom sides of battery cells
13: venting side
14: venting exits
16: electrode terminals
18: crossbeam
20: cover plate
20a: left side end of cover plate
20b: right side end of cover plate
20c: protruding portions of cover plate
22: structural layer of cover plate
24: upper insulation layer of cover plate
26: lower insulation layer of cover plate
30: bottom plate
32: insulation layers
40: first fixation member
42: second fixation member
100: battery system

What is claimed is:

1. A battery system comprising:
a housing;
battery cells forming a battery pack accommodated in the housing, and comprising venting exits for allowing a venting gas stream to exit at top sides or at bottom sides of the battery cells;
a bottom plate covering the bottom sides of the battery cells;
a crossbeam separating neighboring ones of the battery cells, comprising a lower end on the bottom plate, and extending from the bottom plate to be adjacent the top sides of the neighboring ones of the battery cells;
a cover plate extending from one of the neighboring ones of the battery cells over the crossbeam to another one of the neighboring ones of the battery cells to cover an upper end of the crossbeam, and to at least partly cover the top sides of the neighboring ones of the battery cells, the cover plate being configured to be fixed to the crossbeam via a first fixation member.

2. The battery system as claimed in claim 1, wherein the bottom plate is configured to be fixed to the crossbeam via a second fixation member.

3. The battery system as claimed in claim 2, wherein the second fixation member comprise one or more of bolts or screws.

4. The battery system as claimed in claim 1, wherein the first fixation member comprises one or more of bolts or screws.

5. The battery system as claimed in claim 1, wherein the cover plate covers electrode terminals at the top sides of the neighboring ones of the battery cells.

6. The battery system as claimed in claim 1, wherein the cover plate is fixed to the top sides of the neighboring ones of the battery cells.

7. The battery system as claimed in claim 1, wherein the cover plate is adapted to a contour of the top sides of the battery cells and the upper end of the crossbeam.

8. The battery system as claimed in claim 1, wherein the cover plate comprises a structural layer having mechanical rigidity and a first thermal insulation layer.

9. The battery system as claimed in claim 8, further comprising a second thermal insulation layer between the crossbeam and one of the neighboring ones of the battery cells.

10. The battery system as claimed in claim 9, wherein the second thermal insulation layer comprises a woven fabric comprising glass fibres, basalt fibres, or mica fibres, and a matrix support material.

11. The battery system as claimed in claim 8, wherein the first thermal insulation layer comprises a woven fabric comprising glass fibres, basalt fibres, or mica fibres, and a matrix support material.

12. The battery system as claimed in claim 8, wherein the structural layer comprises metal.

13. The battery system as claimed in claim 1, wherein the cover plate fully covers the top sides of the battery cells.

14. The battery system as claimed in claim 13, wherein the venting exits are at the top sides of the battery cells,
wherein the cover plate comprises venting openings aligned with the venting exits of the battery cells, and configured to allow the venting gas stream to pass through the cover plate.

15. An electric vehicle comprising the battery system as claimed in claim 1.
